(19) United States
(12) Patent Application Publication
(10) Pub. No.: US 2009/0245704 A1
(43) Pub. Date: Oct. 1, 2009

(54) SEALED SPHERICAL BEARING DEVICE

(75) Inventor: Alan Gustafson, Lakefield, MN (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: AGCO Corporation, Duluth, GA (US)

(21) Appl. No.: 12/056,086

(22) Filed: Mar. 26, 2008

(51) Int. Cl. F16C 32/06; F16C 11/06

(52) U.S. Cl. 384/108; 403/115

(57) ABSTRACT

The present invention describes methods and apparatus to improve the operation of, and reduce the maintenance required by, a spherical bearing. An exemplary embodiment of the present invention provides a sealed spherical bearing device including a spherical bearing and a flexible shield surrounding a portion of the spherical bearing enabled to articulate in accordance with a rotary motion of the spherical bearing and an oscillatory motion of the spherical bearing. The flexible shield is enabled to reduce the entry of contaminants into the spherical bearing while the spherical bearing is at rest and while the spherical bearing is in motion.

### 1. FIELD OF THE INVENTION

The present invention relates to spherical bearing devices, and more particularly to a sealed spherical bearing device for an agricultural vehicle.

### 2. DESCRIPTION OF RELATED ART

The demands placed upon agricultural equipment are stringent and exacting. Agricultural vehicles, such as row-crop tractors and combines, must perform over rough terrain, at extreme temperatures, and for extensive time periods. At the same time, these agricultural vehicles must provide comfort and reliability to their operators. To perform at these exacting standards, agricultural vehicles must rely on robust, failure-resistant components.

In order to meet these requirements, the large number of components on an agricultural vehicle must provide reliable and consistent operation. One significant component of an agricultural vehicle is the articulation joint assembly. One or more articulation joint assemblies can enable the necessary travel between the major components of an agricultural vehicle. For example, the forward chassis connection to the rear chassis can incorporate an articulation joint assembly that permits the rear chassis to travel and articulate independent from the forward chassis. By enabling improved articulation of various components of the agricultural vehicle, the vehicle can travel over rough and varied terrain without damage. Typically, articulation joint assemblies rely upon a spherical bearing to enable the travel and articulation within the joint.

Spherical bearings can include a spherically ground inner ring housed in a mating outer ring without rolling elements. A spherical bearing can carry radial and axial loads for static and oscillatory applications. A spherical bearing can withstand a relatively high capacity of radial and axial loads because of the large contact area provided between the inner and outer ring.

While spherical bearings are highly desired in many agricultural vehicle applications, due to their ability to withstand a relatively high capacity of radial and axial loads, the integrity of a spherical bearing can be significantly compromised by the entry of contaminants into the contact areas of the bearing. More particularly, the efficiency of the spherical bearing can be diminished if dirt and debris build up in the contact area between the inner ring and the outer ring of the spherical bearing. Therefore, the performance of the spherical bearing is dependent upon maintaining a contaminant free contact area between the inner ring and outer ring of the spherical bearing. In many applications, the spherical bearing is routinely serviced to remove debris from the bearing.

Service of the spherical bearing may involve flushing or washing the bearing to remove debris. If the bearing is not maintenance-free, then the bearing must be re-greased. If the spherical bearing is not routinely serviced, the contaminants and solids inside the bearing may be abrasive to the bearing machinery. Thus, contaminants must be regularly filtered from the bearing in order to ensure the competency and integrity of the spherical bearing. Such regular service often requires an entire agricultural vehicle to be pulled from operation for maintenance. Both the service time required to perform this operation and the inoperability associated with the service are highly costly to the agricultural vehicle operator.

### BRIEF SUMMARY OF THE INVENTION

The present invention describes methods and apparatus to improve the operation of, and reduce the maintenance required by, a spherical bearing. An exemplary embodiment of the present invention provides a sealed spherical bearing device including a spherical bearing and a flexible shield surrounding a portion of the spherical bearing enabled to articulate in accordance with a rotary motion of the spherical bearing and an oscillatory motion of the spherical bearing. The flexible shield is enabled to reduce the entry of contaminants into the spherical bearing while the spherical bearing is at rest and while the spherical bearing is in motion.

These and other objects, features and advantages of the present invention will become more apparent upon reading the following specification in conjunction with the accompanying drawing figures.

### BRIEF DESCRIPTION OF THE FIGURES

FIG. 1 provides an illustration of a conventional spherical bearing 105.

FIG. 2 provides a diagram of a conventional spherical bearing 105.

FIG. 3 provides a cross-sectional illustration of a conventional articulation joint assembly 305 for an agricultural vehicle.

FIG. 4 provides a cross-sectional illustration of a sealed spherical bearing device 400 in accordance with an exemplary embodiment of the present invention.

FIG. 5 provides a cross-sectional illustration of an articulation joint assembly 405 in accordance with an exemplary embodiment of the present invention.

FIG. 6 provides an illustration of an articulation joint assembly 405 implemented an agricultural vehicle in accordance with an exemplary embodiment of the present invention.

FIG. 7 provides an illustration of an articulation joint assembly 405 implemented in a tractor 705 in accordance with an exemplary embodiment of the present invention.

### DETAILED DESCRIPTION OF PREFERRED EMBODIMENTS

The present invention addresses the drawbacks in the prior art with respect to the contamination and maintenance of spherical bearings in agricultural vehicles. In accordance with an exemplary embodiment of the present invention, a spherical bearing device is provided that reduces contamination and corruption from dirt and debris. Furthermore, an exemplary embodiment of the present invention provides a spherical bearing device with improved reliability and performance.

In an exemplary embodiment, the present invention provides a sealed spherical bearing device including a spherical bearing and a flexible shield surrounding a portion of the spherical bearing enabled to articulate in accordance with a rotary motion of the spherical bearing and an oscillatory motion of the spherical bearing. The flexible shield is enabled to reduce the entry of contaminants into the spherical bearing while the spherical bearing is at rest and while the spherical bearing is in motion.

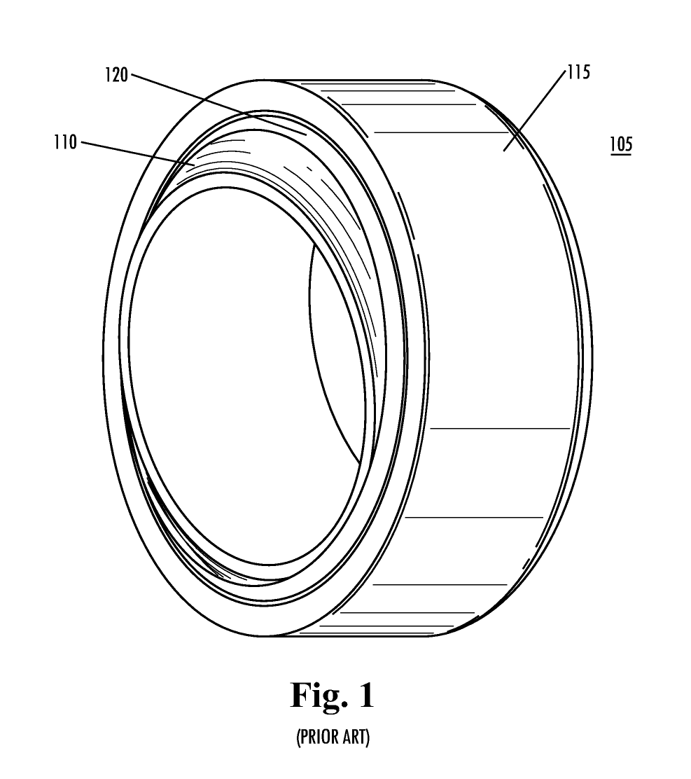

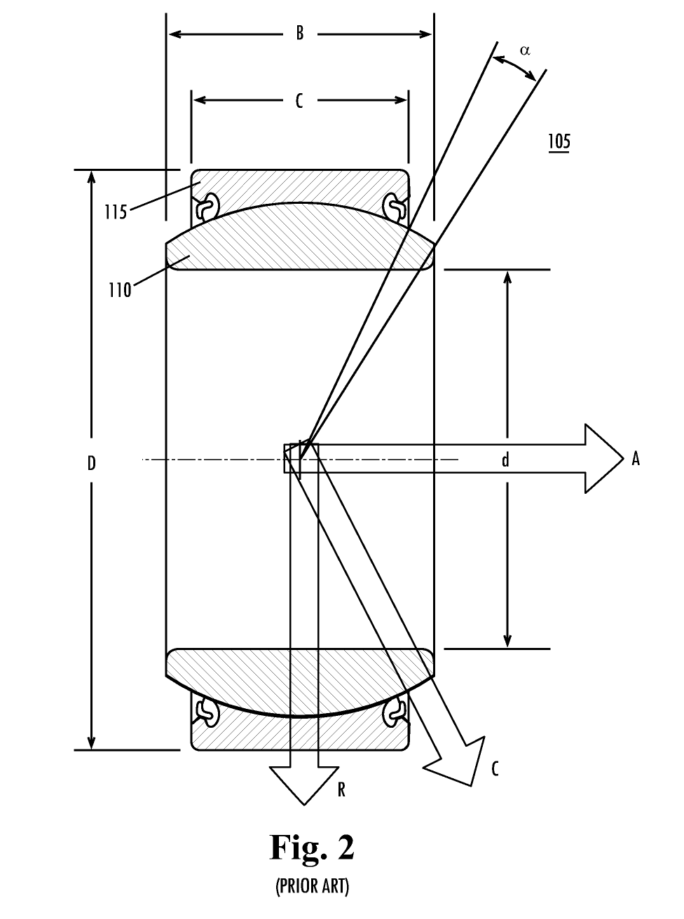

FIG. 1 provides an illustration of a conventional spherical bearing 105. The conventional spherical bearing 105 shown in FIG. 1 can have a spherically ground inner ring 110 and a mating outer ring 115 without any rolling elements. The spherical bearing 105 can provide a lip seal 120 to aid in reducing dirt and other contaminant entry into the spherical bearing 105 in certain configurations. For example, the lip seal 120 shown in FIG. 1 can help to reduce contaminant entry when the spherical bearing 105 is implemented in a system in which the orientation of the spherical bearing 105 is such that an axial load force on the spherical bearing 105 is perpendicular to gravitational force, in other words, the spherical bearing 105 is in a horizontal configuration (not shown in FIG. 1). The horizontal configuration of the spherical bearing 105, shown in FIG. 2, can permit the lip seal 120 to deflect some debris and contaminants. The lip seal 120 is less effective, however, when the spherical bearing 105 is not in a horizontal orientation, as a layer of debris can collect on top of the lip seal, making sealing more difficult.

FIG. 2 provides a diagram of a conventional spherical bearing 105. As shown in FIG. 2, the spherical bearing 105 can have an inner ring 110 and a mating outer ring 115. The outer ring 115 can have a diameter “D,” and width “C,” as shown in FIG. 2. The inner ring 110 can have a diameter “d” and a width “B.” The architecture of the spherical bearing 105 is such that the spherical bearing 105 can bear a radial load, illustrated by the load direction arrow “R,” and an axial load, illustrated by the load direction arrow “A” in FIG. 2. Furthermore, the spherical bearing 105 can bear a combined load, illustrated by the load direction arrow “C” in FIG. 2, representing a combined axial and radial load. The spherical bearing 105 in FIG. 2 is shown in an horizontal configuration, in which the direction of an axial load on the spherical bearing 105 is parallel to the ground.

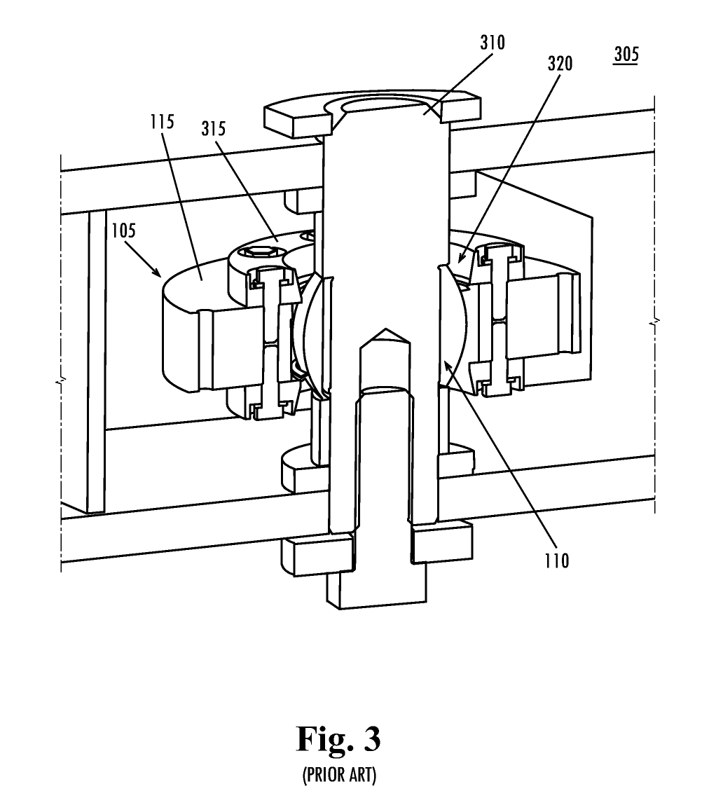

FIG. 3 provides a cross-sectional illustration of a conventional articulation joint assembly 305 for an agricultural vehicle. The conventional articulation joint assembly 305 shown in FIG. 3 can provide the flexible link between two larger components. For example, the articulation joint assembly 305 shown in FIG. 3 can provide a link between the front chassis and rear chassis of an agricultural vehicle. As shown in FIG. 3, the articulation joint assembly 305 can incorporate a spherical bearing 105 in communication with a connection shaft 310, such that the spherical bearing 105 can permit the connection shaft 310 to travel and articulate. The inner ring 110 of the spherical bearing 105 is provided in communication with the connection shaft 310. In an exemplary embodiment, the inner ring 110 can permit movement within the outer ring 115 of the spherical bearing 105. The spherical bearing 105 shown in FIG. 3 provides bearing retaining rings 315 to retain the spherical bearing 105 configuration and ensure a stable relationship between the inner ring 110 and outer ring 115.

While the conventional articulation joint assembly 305 with spherical bearing, 105 shown in FIG. 3, enables many significant benefits for agricultural vehicles, it is subject to significant contamination and corruption from dirt and debris. This contamination and corruption can lead to failure of the articulation joint assembly 305; thus, debilitation of a significant component of an agricultural vehicle. The susceptibility of the spherical bearing 105 of the articulation joint assembly 305 is due in large part to its orientation. Although the vertical orientation of the spherical bearing 105 shown in FIG. 3, where the axial load direction is substantially parallel to gravitational force, provides a preferred orientation for the performance of the articulation joint assembly 305, it makes the spherical bearing 105 susceptible to degradation due to contamination from dirt and debris. Significantly, in the articulation joint assembly 305 shown in FIG. 3, a cavity 320 is created above the inner ring 110 of the spherical bearing 105, between the inner ring 110 and the outer ring 115 of the spherical bearing 105. This cavity can collect dirt and debris, which then sits on top of the inner ring 110 of the spherical bearing 105. Thereby, the action and movement of the articulation joint assembly 305 results in penetration of the contaminants into the inner ring 110 of the spherical bearing 105. Furthermore, the effectiveness of the lip seal 120 of the spherical bearing 105, shown in FIG. 1, is compromised when the spherical bearing 105 is in the orientation shown in FIG. 3.

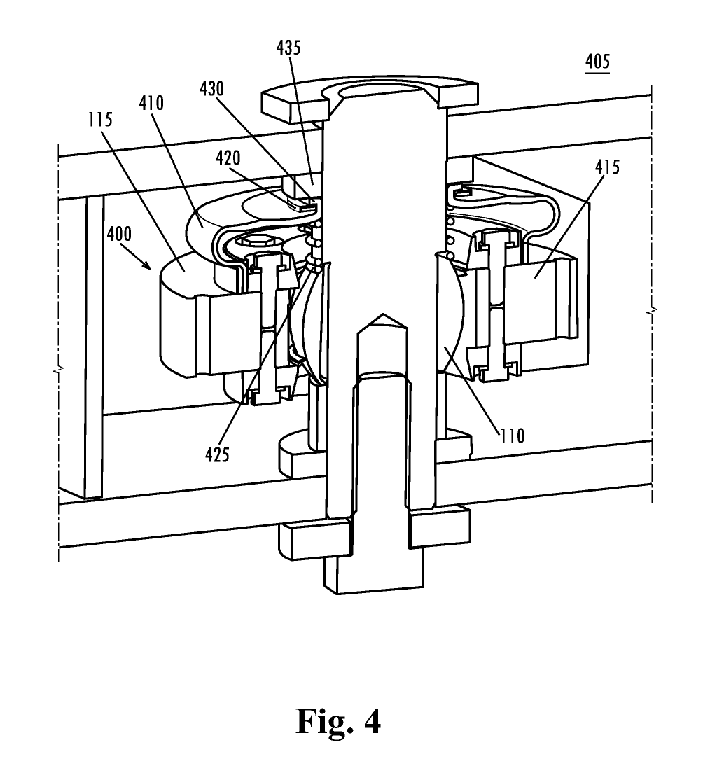

FIG. 4 provides a cross-sectional illustration of a sealed spherical bearing device 400 in accordance with an exemplary embodiment of the present invention. As shown in FIG. 4, an exemplary embodiment of the present invention, an articulation joint assembly 405 can be provided that includes a sealed spherical bearing device 400. As shown in FIG. 4, in an exemplary embodiment the sealed spherical bearing device 400 can include a flexible shield 410 and spherical bearing 415. In the exemplary embodiment depicted in FIG. 4, the flexible shield 410 can surround a portion of the inner ring 110 and the outer ring 115 of the spherical bearing 415. As shown in FIG. 4, the flexible shield 410 in an exemplary embodiment can be configured on the top of spherical bearing 415 when the sealed spherical bearing device 400 is in a vertical orientation. In an exemplary embodiment, a flexible shield 410 is only provided on the top of the vertically oriented spherical bearing 415. In an alternative embodiment, a flexible shield 410 is provided on both the top and the bottom of the spherical bearing 415.

Those of skill in the art will appreciate that the flexible shield 410 of the sealed spherical bearing device 400 can be configured in numerous ways in various embodiments. As shown in the exemplary embodiment depicted in FIG. 4, the flexible shield 410 can extend to the edges of the bearing retaining rings 315 of the spherical bearing 415. In an alternative embodiment the flexible shield 410 can extend around the full perimeter of the outer ring 115 of the spherical bearing 415. Furthermore, in another embodiment of the sealed spherical bearing device 400 can provide a flexible shield 410 that covers a portion of the articulation joint assembly 405.

The flexible shield 410 in an exemplary embodiment can be enabled to articulate in accordance with a rotary motion of the sealed spherical bearing device 400 and an oscillatory motion of the sealed spherical bearing device 400. Thereby, the flexible shield 410 can adequately protect an exemplary embodiment of the sealed spherical bearing device 400 from debris and contaminants without limiting the functionality of the spherical bearing 415. Additionally, the flexible shield 410 can protect an exemplary embodiment of the sealed spherical bearing device 400 without reducing the functionality of the articulation joint assembly 405.

Significantly, the flexible shield 410 of an exemplary embodiment of the sealed spherical bearing device 400 is enabled to reduce the entry of contaminants into the spherical bearing 415 while the spherical bearing 415 is at rest and while the spherical bearing 415 is in motion. More particularly, the flexible shield 410 of the sealed spherical bearing device 400 can deflect dirt and debris falling on the housing of the sealed spherical bearing device 400. As shown in FIG. 3, conventional spherical bearings are vulnerable due to the cavity 320 that exists above the inner ring 110 of the spherical bearing 105, between the inner ring 110 and the outer ring 115 of the spherical bearing 105. An exemplary embodiment of the sealed spherical bearing device 400, however, does not have an exposed cavity 320 above the inner ring 110 of the sealed spherical bearing device 400. As shown in FIG. 4, the flexible shield 410 of the sealed spherical bearing device 400, in an exemplary embodiment, shields the space above the inner ring 110. By enclosing the cavity 320 above the inner ring 110, the flexible shield 410 of an exemplary embodiment of the sealed spherical bearing device 400 prevents dirt and debris from collecting above the inner ring 110. Because the collection of dirt and debris above the inner ring 110 of an exemplary embodiment of the sealed spherical bearing device 400 is greatly reduced by the flexible shield 410 in an exemplary embodiment, dirt and debris does not work itself into the spherical bearing 415 upon the action and rotation of the spherical bearing 415.

Those of skill in the art will appreciate that the flexible shield 410 of the sealed spherical bearing device 400 can be implemented in a variety of ways to provide reliable attachment to the connection shaft 310 of the articulation joint assembly 405. In the exemplary embodiment shown in FIG. 4, the flexible shield 410 can be made from an elastic material that is both flexible and wear resistant so as to withstand the rotary motion of the spherical bearing 415. Additionally, as shown in FIG. 4, the flexible shield 410 in an exemplary embodiment can be attached to the connection shaft 310 by a support ring 420. In an exemplary embodiment, the support ring 420 can help to maintain the circular shape of the flexible shield 410, even when the flexible shield 410 is distorted due to the oscillation of the spherical bearing 415. As shown in FIG. 4, the sealing lip 430 of the flexible shield 410 is maintained in firm contact with the sealing surface 435 by a loading spring 425. The loading spring 425, in an exemplary embodiment, can be provided along the connection shaft 310 and inside the flexible shield 410. The loading spring 425, therefore, can maintain contact between the sealing lip 430 of the flexible shield 410 and the surrounding sealing surface 435 in an exemplary embodiment. Those of skill in the art will appreciate that the flexible shield 410 of the sealed spherical bearing device 400 can be implemented with a variety of other suitable mechanisms in accordance with alternative embodiments.

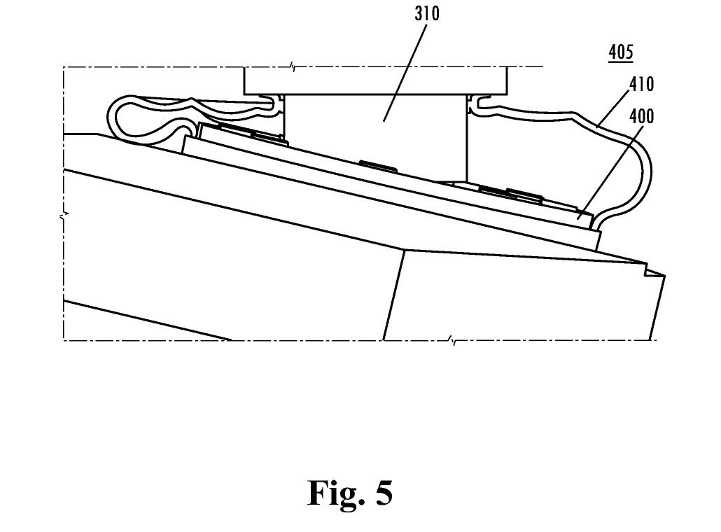

FIG. 5 provides a cross-sectional illustration of an articulation joint assembly 405 in accordance with an exemplary embodiment of the present invention. In the exemplary embodiment shown in FIG. 5, the articulation joint assembly 405 has been configured with a sealed spherical bearing device 400 having a flexible shield 410. As shown in FIG. 5, the flexible shield 410 of an exemplary embodiment of the sealed spherical bearing device 400 can withstand stress caused by the activation of the articulation joint assembly 405. Therefore, when the articulation joint assembly 405 of an exemplary embodiment undergoes an orbital motion or an oscillatory motion, the flexible shield 410 can bend to accommodate that motion. The accommodation of this motion may cause the flexible shield 410 to compress or expand. As shown in the exemplary embodiment of the flexible shield 410 in FIG. 5, the portion of the flexible shield 410 to the left of the connection shaft 310 is compressed and the portion of the flexible shield 410 to the right of the connection shaft 310 is expanded.

In an exemplary embodiment, the flexible shield 410 will distort in the opposite fashion when the articulation joint assembly 405 moves in the opposite direction. As shown in FIG. 5, the top of the spherical bearing 415 is not exposed to the elements in an exemplary embodiment. Thus, the cavity is above the spherical bearing 415 of an exemplary embodiment does not collect dirt and debris. In an exemplary embodiment, the articulation joint assembly 405 can be provided with a full range of motion by the sealed spherical bearing device 400, while at the same time, significantly reducing exposure of the sealed spherical bearing device 400 to contaminants.

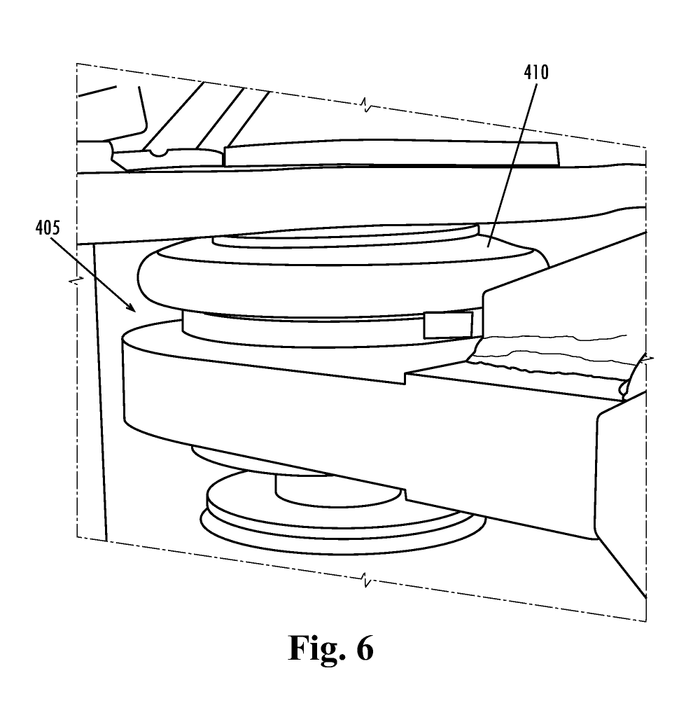

FIG. 6 provides an illustration of an articulation joint assembly 405 implemented an agricultural vehicle in accordance with an exemplary embodiment of the present invention. As shown in FIG. 6, an exemplary embodiment of the articulation joint assembly 405 can be provided with a flexible shield 410 on the top portion of the articulation joint assembly 405. In an exemplary embodiment, this flexible shield 410 can partially enclose the sealed spherical bearing device 400 of the articulation joint assembly 405. Thus, even though the exemplary embodiment of the articulation joint assembly 405 is exposed to the elements, as shown in FIG. 6, the sealed spherical bearing device 400 is protected from contamination by dirt and debris by the flexible shield 410. Where conventional spherical bearings would be vulnerable to the collection of dirt in a cavity above the inner ring of the spherical bearing, the inner ring of the exemplary embodiment of the sealed spherical bearing device 400 is encapsulated by flexible shield 410.

One significant advantage of the sealed spherical bearing device 400 provided in accordance with an exemplary embodiment of the present invention, is that it requires minimal maintenance. Conventional spherical bearings require flushing in order to remove contaminant deposits, such as dirt and debris. Thus, an articulation joint assembly must be regularly taken out of service and flushed to remove the damaging dirt and debris and preserve the integrity of the spherical bearing. An exemplary embodiment of the sealed spherical bearing device 400 does not have to be flushed as often as conventional bearings in order to maintain the integrity of the bearing, because the flexible shield 410 greatly reduces the entry of contaminants, such as dirt and debris, into the bearing. Therefore, as no dirt or debris enters the bearing, there is nothing to flush from the bearing and maintenance is rarely required.

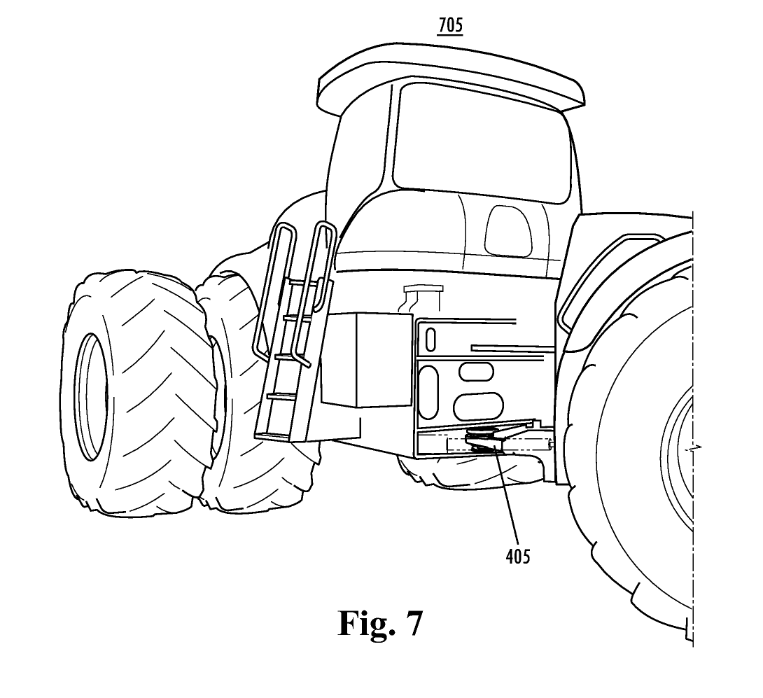

FIG. 7 provides an illustration of an articulation joint assembly 405 implemented in a tractor 705 in accordance with an exemplary embodiment of the present invention. As shown in the FIG. 7, an exemplary embodiment of the articulation joint assembly 405 can be implemented to join the front cab chassis with the rear chassis of the tractor 705. Furthermore, FIG. 7 illustrates that the articulation joint assembly 405, in an exemplary embodiment, can be partially or fully exposed to the environment. The flexible shield 410 of the sealed spherical bearing device 400 in the articulation joint assembly 405 can, however, help to preserve the integrity of the sealed spherical bearing device 400 by preventing dirt and debris from entering the bearing.

While the invention has been disclosed in its preferred forms, it will be apparent to those skilled in the art that many modifications, additions, and deletions can be made therein without departing from the spirit and scope of the invention and its equivalents as set forth in the following claims.

What is claimed is:

1. A sealed spherical bearing device comprising:
a spherical bearing;
a flexible shield surrounding a portion of the spherical bearing enabled to articulate in accordance with a rotary motion of the spherical bearing and an oscillatory motion of the spherical bearing; and
the flexible shield enabled to reduce the entry of contaminants into the spherical bearing while the spherical bearing is at rest and while the spherical bearing is in motion.

2. The sealed spherical bearing device of claim 1, wherein the spherical bearing includes an inner ring and the flexible shield encloses a portion of the inner ring.

3. The sealed spherical bearing device of claim 2, wherein the flexible shield encloses the entire inner ring of the spherical bearing.

4. The sealed spherical bearing device of claim 1, wherein the spherical bearing includes an inner ring and an outer ring and the flexible shield encloses a portion of the inner ring and the outer ring.

5. The sealed spherical bearing device of claim 1, wherein the flexible shield is enabled to distort under stress caused by the motion of the spherical bearing.

6. The sealed spherical bearing device of claim 6, wherein the distortion is equivalent to a range of motion of the spherical bearing.

7. The sealed spherical bearing device of claim 1, wherein the spherical bearing is mounted in an orientation in which an axial load on the spherical bearing is substantially parallel to gravitational force.

8. The sealed spherical bearing device of claim 7, wherein the flexible shield encloses a cavity on top of an inner ring of the spherical bearing.

9. The sealed spherical bearing device of claim 1, wherein the spherical bearing does not require flushing.

10. An articulation joint assembly comprising:
a spherical bearing;
a connection shaft in communication with spherical bearing;
a flexible shield surrounding a portion of the spherical bearing enabled to articulate in accordance with a rotary motion of the spherical bearing and an oscillatory motion of the spherical bearing; and
the flexible shield enabled to reduce the entry of contaminants into the spherical bearing while the spherical bearing is at rest and while the spherical bearing is in motion.

11. The articulation joint assembly of claim 10, wherein the flexible shield encloses a top portion of articulation joint assembly.

12. The articulation joint assembly of claim 10, wherein the spherical bearing includes an inner ring and the flexible shield encloses a portion of the inner ring.

13. The articulation joint assembly of claim 12, wherein the flexible shield encloses the entire inner ring of the spherical bearing.

14. The articulation joint assembly of claim 10, wherein the flexible shield is enabled to distort under stress caused by the motion of the connection shaft.

15. The articulation joint assembly of claim 14, wherein the distortion is equivalent to a range of motion of the spherical bearing.

16. The articulation joint assembly of claim 10, wherein the spherical bearing is mounted in an orientation in which an axial load on the spherical bearing is substantially parallel to gravitational force.

17. The articulation joint assembly of claim 16, wherein the flexible shield encloses a cavity on top of an inner ring of the spherical bearing.

18. A reduced-maintenance spherical bearing comprising:
an inner ring;
an outer ring;
a flexible shield surrounding a portion of the inner ring enabled to articulate in accordance with a rotary motion of the spherical bearing and an oscillatory motion of the spherical bearing; and
the flexible shield enabled to reduce the entry of contaminants into the spherical bearing while the spherical bearing is at rest and while the spherical bearing is in motion.
